(19) United States
(12) Patent Application Publication
(10) Pub. No.: US 2026/0138245 A1
(43) Pub. Date: May 21, 2026

(54) SOCKET STRUCTURE FOR STRIPPED SCREW OR NUT

(71) Applicant: Ching-Ti Lin, Taichung City (TW)

(72) Inventor: Ching-Ti Lin, Taichung City (TW)

(21) Appl. No.: 18/954,329

(22) Filed: Nov. 20, 2024

(51) Int. Cl. B25B 23/10; B25B 13/06; B25B 23/00

(52) U.S. Cl. CPC B25B 23/108; B25B 13/065; B25B 23/0035

(57) ABSTRACT

A socket structure includes a socket having a first end provided with a drive portion and a second end provided with an operation portion. The drive portion is provided with a driving hole for mounting a driving tool. The operation portion is provided with an operation hole for mounting a nut or a screw. The operation hole is provided with multiple engaging faces arranged symmetrically. Viewed from a top view, each of the engaging faces is provided with a deflection angle with a center of the operation hole served as a center of circle. Viewed from a side view, each of the engaging faces has an upper end provided with a vertical portion perpendicular to a horizontal plane, and has a lower end provided with a tapered portion having an obtuse angle relative to the horizontal plane.

### BACKGROUND OF THE INVENTION

### Field of the Invention

The present invention relates to a socket and, more particularly, to a socket structure available for a stripped screw or nut.

### Description of the Related Art

A conventional socket is driven by a driving tool to operate and rotate a screw or nut. The driving tool is an electric device or a pneumatic device. However, when the screw or nut is worn out and becomes smaller due to wear, the screw or nut easily slips from the socket, resulting in a stripped screw or nut. Occurrence of a stripped screw or nut is due to design of the screw or nut, an excessive torque, and a wrong tool size. The reasons of a stripped screw or nut are described as follows.
1. The contact surface between the socket and the screw or nut is too

small and the gap therebetween is too large, resulting in an uneven force distribution and a poor torque transmission efficiency.
2. When the torque applied by the driving tool on the screw or nut is

too large, the screw or nut is easily stripped from the socket and may be worn out or broken due to an excess torque.
3. The size of the socket does not fit the screw or nut. Thus, when the socket is used to operate the screw or nut, the torque transmission efficiency is poor, and the screw or nut is easily damaged.

### BRIEF SUMMARY OF THE INVENTION

The primary objective of the present invention is to provide a socket structure that avoids occurrence of a stripped screw or nut.

In accordance with the present invention, there is provided a socket structure comprising a socket having a first end provided with a drive portion and a second end provided with an operation portion opposite to the drive portion. The drive portion is provided with a driving hole for mounting a driving tool. The operation portion is provided with an operation hole for mounting a nut or a screw. The operation hole is provided with multiple engaging faces arranged symmetrically. Viewed from a top view, each of the engaging faces is provided with a deflection angle with a center of the operation hole served as a center of circle. Viewed from a side view, each of the engaging faces has an upper end provided with a vertical portion perpendicular to a horizontal plane, and each of the engaging faces has a lower end provided with a tapered portion having an obtuse angle relative to the horizontal plane.

According to the primary advantages of the present invention, when the nut or screw is worn out and becomes smaller due to wear, the tapered portion of each of the engaging faces presses the nut at a normal state, so that the engaging faces engage the nut exactly, to prevent the nut from being stripped or slipping. Thus, a stripped screw or nut is avoided when the socket is driven to rotate the nut.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective and sectional view of a socket structure in accordance with the first preferred embodiment of the present invention.

FIG. 2 is a top planar view of the socket structure in accordance with the first preferred embodiment of the present invention.

FIG. 3 is a cross-sectional view of the socket structure taken along line B-B as shown in FIG. 2.

FIG. 4 is a cross-sectional view of the socket structure taken along line F-F as shown in FIG. 3.

FIG. 5 is a schematic operational view showing usage of the socket structure in accordance with the first preferred embodiment of the present invention.

FIG. 6 is a cross-sectional view of the socket structure taken along line G-G as shown in FIG. 5.

FIG. 7 is another schematic operational view showing usage of the

### Socket Structure in Accordance With the First Preferred Embodiment of the Present invention.

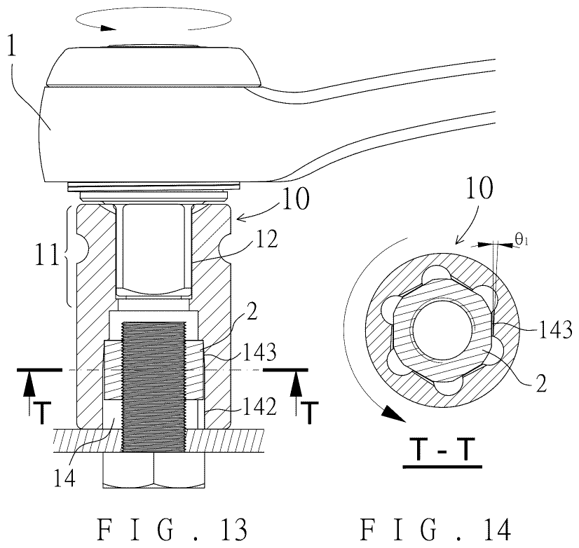

FIG. 8 is a cross-sectional view of the socket structure taken along line H-H as shown in FIG. 7.

FIG. 9 is a perspective and sectional view of a socket structure in accordance with the second preferred embodiment of the present invention.

FIG. 10 is a top planar view of the socket structure in accordance with the second preferred embodiment of the present invention.

FIG. 11 is a cross-sectional view of the socket structure taken along line S-S as shown in FIG. 10.

FIG. 12 is a cross-sectional view of the socket structure taken along line M-M as shown in FIG. 11.

FIG. 13 is a schematic operational view showing usage of the socket structure in accordance with the second preferred embodiment of the present invention.

FIG. 14 is a cross-sectional view of the socket structure taken along line T-T as shown in FIG. 13.

### DETAILED DESCRIPTION OF THE INVENTION

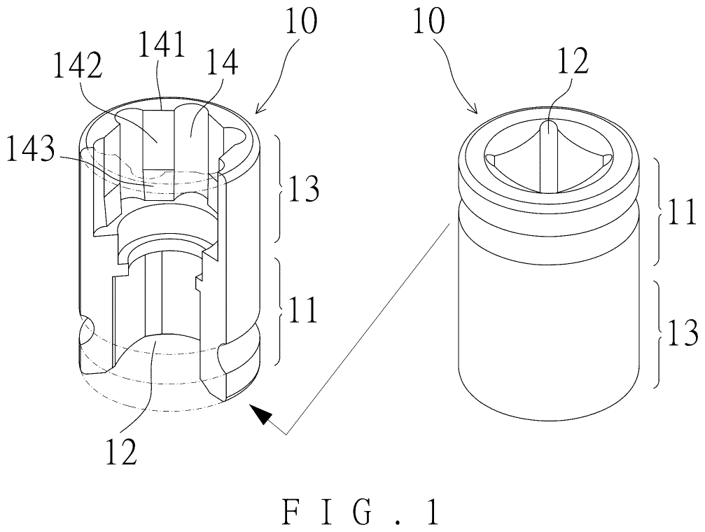

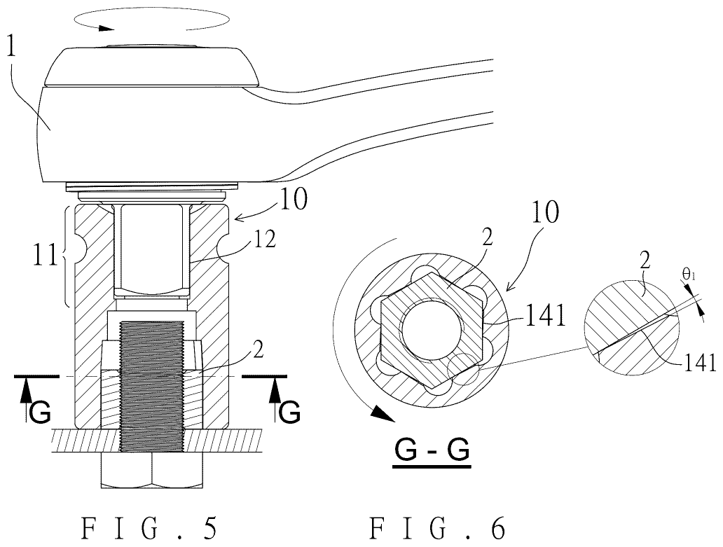

Referring to the drawings and initially to FIGS. 1-6, a socket structure in accordance with the preferred embodiment of the present invention

comprises a socket 10 having a first end provided with a drive portion 11 and a second end provided with an operation portion 13 opposite to the drive portion 11. The drive portion 11 is provided with a driving hole 12 for mounting a driving tool 1. The driving tool 1 is a pneumatic tool, an electric tool or a T-type hand operated tool. The operation portion 13 is provided with an operation hole 14 for mounting a nut 2 or a screw. The operation hole 14 is provided with multiple engaging faces 141 arranged symmetrically. Viewed from a top view, each of the engaging faces 141 is provided with a deflection angle θ₁ with a center of the operation hole 14 served as a center of circle. Viewed from a side view, each of the engaging faces 141 has an upper end provided with a vertical portion 142 perpendicular to a horizontal plane, and each of the engaging faces 141 has a lower end provided with a tapered portion 143 having an obtuse angle θ₂ relative to the horizontal plane.

In the preferred embodiment of the present invention, the deflection angle θ₁ of each of the engaging faces 141 is equal to 3 □.

In the preferred embodiment of the present invention, the obtuse angle θ₂ of the tapered portion 143 is equal to 93 □.

In the preferred embodiment of the present invention, the driving hole 12 has a square shape. Alternatively, the driving hole 12 has a hexagonal shape.

In the preferred embodiment of the present invention, the operation hole 14 has a hexagonal shape, and the nut 2 or screw has a hexagonal shape. Alternatively, the operation hole 14 has a square shape, and the nut 2 or screw has a square shape.

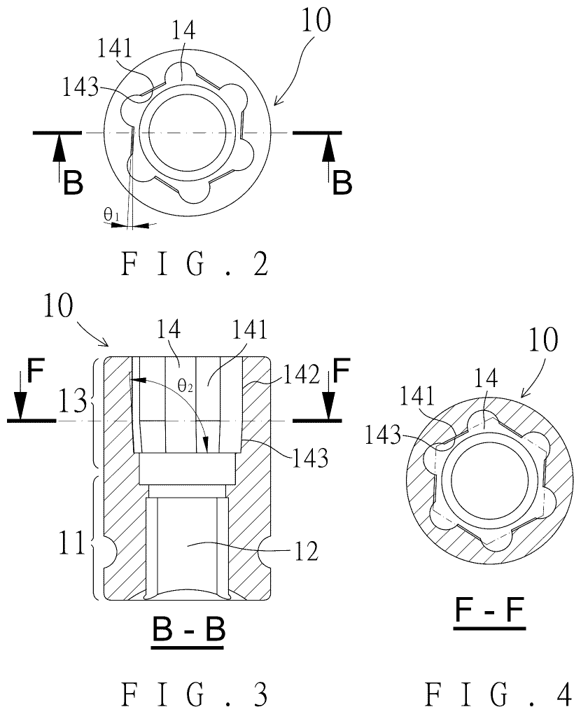

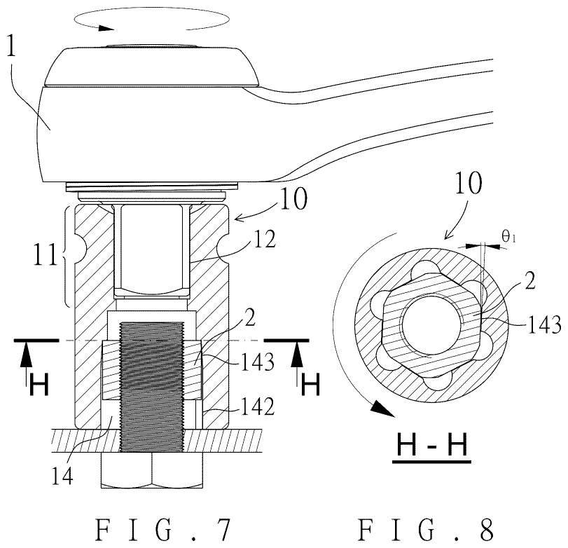

In the preferred embodiment of the present invention, the operation hole 14 is provided with six (or four) engaging faces 141. The six engaging faces 141 construct a hexagonal profile as shown in FIG. 4, which is rotated through an angle about the center of the operation hole 14 to define the deflection angle θ₁ as shown in FIG. 2.

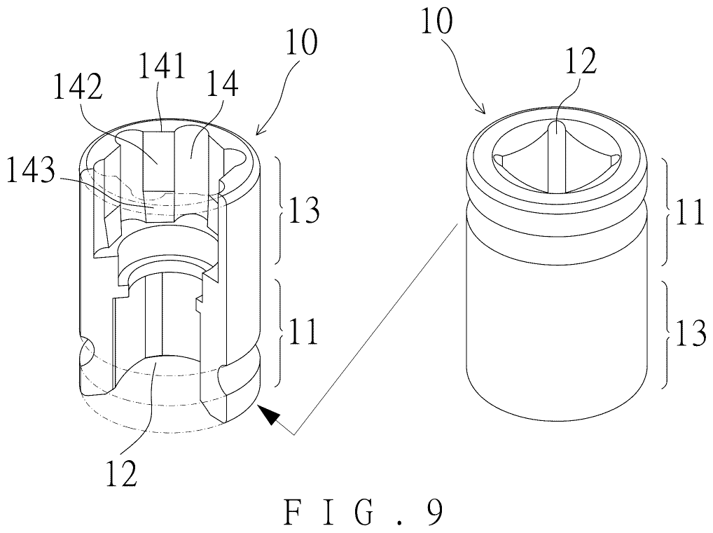

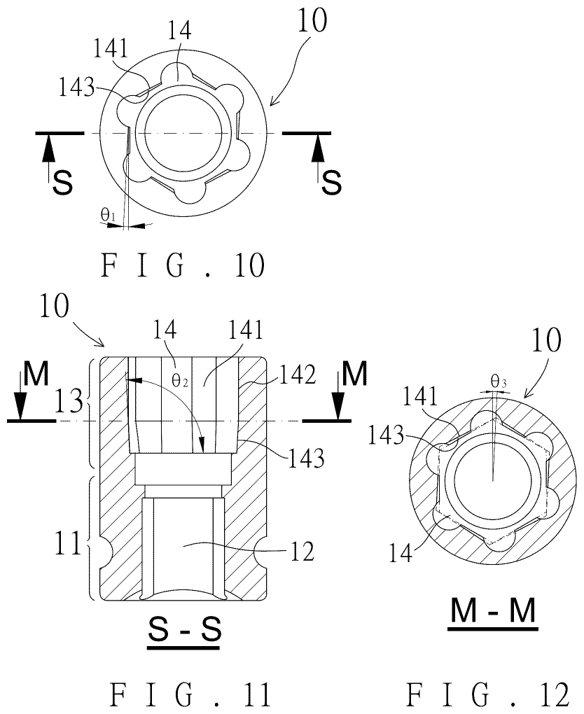

In operation, referring to FIGS. 5 and 6 with reference to FIGS. 1-4, the socket 10 is driven by the driving tool 1 to operate the nut 2 as shown in FIG. 5. At this time, the nut 2 is not worn out and has a normal size. When the engaging faces 141 are mounted on the nut 2, the vertical portion 142 of each of the engaging faces 141 contacts and presses the nut 2, so that the engaging faces 141 engage the nut 2 exactly. At this time, the deflection angle θ₁ increases the torque of the socket 10 when the socket 10 is driven to rotate the nut 2.

Referring to FIGS. 7 and 8 with reference to FIGS. 1-4, the nut 2 is worn out and has a size becoming smaller due to wear. When the engaging faces 141 are mounted on the nut 2, the tapered portion 143 of each of the engaging faces 141 contacts and presses the nut 2, so that the engaging faces 141 engage the nut 2 exactly, to prevent the nut 2 from being stripped or slipping. Thus, a stripped screw or nut is avoided when the socket 10 is driven to rotate the nut 2.

Referring to FIGS. 9-14, the tapered portion 143 of each of the engaging faces 141 is provided with a torsion angle θ₃ to increase the torque of the socket 10 when the socket 10 is driven to rotate the nut 2. Preferably, the torsion angle θ₃ of the tapered portion 143 is equal to 3 □.

Accordingly, when the nut 2 or screw is worn out and becomes smaller due to wear, the tapered portion 143 of each of the engaging faces 141 presses the nut 2 at a normal state, so that the engaging faces 141 engage the nut 2 exactly, to prevent the nut 2 from being stripped or slipping. Thus, a stripped screw or nut is avoided when the socket 10 is driven to rotate the nut 2.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the scope of the invention.

1. A socket structure comprising:
a socket having a first end provided with a drive portion and a second end provided with an operation portion opposite to the drive portion;
wherein:
the drive portion is provided with a driving hole for mounting a driving tool;
the operation portion is provided with an operation hole for mounting a nut or a screw;
the operation hole is provided with multiple engaging faces arranged symmetrically;
viewed from a top view, each of the engaging faces is provided with a deflection angle with a center of the operation hole served as a center of circle; and
viewed from a side view, each of the engaging faces has an upper end provided with a vertical portion perpendicular to a horizontal plane, and each of the engaging faces has a lower end provided with a tapered portion having an obtuse angle relative to the horizontal plane.

2. The socket structure as claimed in claim 1, wherein the deflection angle of each of the engaging faces is equal to 3 □.

3. The socket structure as claimed in claim 1, wherein the obtuse angle of the tapered portion is equal to 93 □.

4. The socket structure as claimed in claim 1, wherein the driving hole has a square shape.

5. The socket structure as claimed in claim 1, wherein the driving hole has a hexagonal shape.

6. The socket structure as claimed in claim 1, wherein the operation hole has a hexagonal shape.

7. The socket structure as claimed in claim 1, wherein the operation hole has a square shape.

8. A socket structure comprising:
a socket having a first end provided with a drive portion and a second end provided with an operation portion opposite to the drive portion;
wherein:
the drive portion is provided with a driving hole for mounting a driving tool;
the operation portion is provided with an operation hole for mounting a nut or a screw;
the operation hole is provided with multiple engaging faces arranged symmetrically;
viewed from a top view, each of the engaging faces is provided with a deflection angle with a center of the operation hole served as a center of circle;
viewed from a side view, each of the engaging faces has an upper end provided with a vertical portion perpendicular to a horizontal plane, and each of the engaging faces has a lower end provided with a tapered portion having an obtuse angle relative to the horizontal plane; and
the tapered portion of each of the engaging faces is provided with a torsion angle.

9. The socket structure as claimed in claim 8, wherein the deflection angle of each of the engaging faces is equal to 3 □.

10. The socket structure as claimed in claim 8, wherein the obtuse angle of the tapered portion is equal to 93 □.

11. The socket structure as claimed in claim 8, wherein the torsion angle of the tapered portion is equal to 3 □.

12. The socket structure as claimed in claim 8, wherein the driving hole has a square shape.

13. The socket structure as claimed in claim 8, wherein the driving hole has a hexagonal shape.

14. The socket structure as claimed in claim 8, wherein the operation hole has a hexagonal shape.

15. The socket structure as claimed in claim 8, wherein the operation hole has a square shape.
